(19) United States
(12) Patent Application Publication
(10) Pub. No.: US 2013/0011668 A1
(43) Pub. Date: Jan. 10, 2013

(54) FLAME RETARDANT THERMOPLASTIC COMPOSITE

(75) Inventors: Garry Glenn Belcher, JR., Greensboro, NC (US); John S. Ammondson, Jamestown, NC (US)

(73) Assignee: Viking Polymers, LLC, Jamestown, NC (US)

(21) Appl. No.: 13/532,596

(22) Filed: Jun. 25, 2012

Related U.S. Application Data
(60) Provisional application No. 61/501,107, filed on Jun. 24, 2011.
(60) Provisional application No. 61/512,270, filed on Jul. 27, 2011.

(51) Int. Cl. C08L 75/12; C08K 3/38; C08K 3/22; B05D 3/00; C08L 27/06; B32B 27/40; B32B 27/08; C08K 3/24; C08K 11/00

(52) U.S. Cl. 428/339; 525/123; 524/434; 524/405; 524/436; 524/80; 428/423.1; 427/374.1

(57) ABSTRACT

An extruded structural article is disclosed. The article has a cap layer comprising a flame retardant thermoplastic urethane material. The flame retardant thermoplastic urethane material is a blend of a thermoplastic urethane and a flame retardant polymer, such as a halogenated polymer. The thermoplastic urethane material is cross-linked using cross-linking agents such as radical initiators to improve strength, weather resistance, and resistance to scratching, abrasion, or marring. The flame retardant thermoplastic urethane is typically blended in a first extrusion with minimal cross-linking, and then applied to a structural article during a second extrusion in which the cross-linking reaction is activated.

### CROSS-REFERENCE TO RELATED APPLICATIONS

This application claims benefit of U.S. Provisional Patent Application Ser. Nos. 61/501,107, filed Jun. 24, 2011, and 61/512,270, filed Jul. 27, 2011, which are both incorporated herein by reference.

### FIELD

Embodiments of the invention relate to synthetic structural articles and methods of making synthetic structural articles. More specifically, embodiments described herein relate to flame retardant thermoplastic and thermoset composites usable for synthetic structural articles.

### BACKGROUND

Wood structural members are slowly being replaced by synthetic structural members as their relative costs, direct and indirect, converge. Synthetic structural articles such as foam decking, railing, fencing, and siding materials exhibit good strength and usability, and may be capped with a finishing layer to apply colors and textures for an aesthetic appearance. Such structural articles are frequently constructed with a PVC or composite core that may or may not be foamed, and a styrenic capping layer that accepts coloring and texturing, and resists weathering.

Thermoplastic materials are popular due to their ability to be processed and/or shaped prior to hardening, but many thermoplastic and thermoset materials are highly flammable, reducing their utility in consumer applications such as structural materials. Conventional methods of reducing the flammability of these materials rely on expensive precursors and blend stocks, some of which may also be toxic and may have poor weather resistance. Thus, there remains a need for a flame retardant thermoplastic material that exhibits good weather resistance and has good strength as a structural material.

### SUMMARY

Embodiments described herein provide a synthetic structural article having a rigid extruded core comprising a polymeric material and a cap material comprising a thermoplastic urethane material blended with a halogen-containing polymer. The halogen-containing polymer may be a polymer with halogen atoms attached to the polymer backbone. In some embodiments, a tie layer may be inserted between the core and the cap to improve adhesion and/or allow use of a thinner cap layer.

### BRIEF DESCRIPTION OF THE DRAWINGS

So that the manner in which the above-recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a cross-sectional view of a structural article according to one embodiment.

FIG. 2 is a cross-sectional view of a structural article according to another embodiment.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Embodiments described herein provide synthetic structural articles such as decking articles, railing articles, fencing articles, and siding articles, that comprise a rigid polymeric core material and a flame retardant thermoplastic capping material (FR). The capping material may be a weather resistant thermoplastic urethane (TPU) alloy having flame resistance of at least class C as defined by ASTM E84. Some embodiments may have ASTM E84 flame resistance class B.

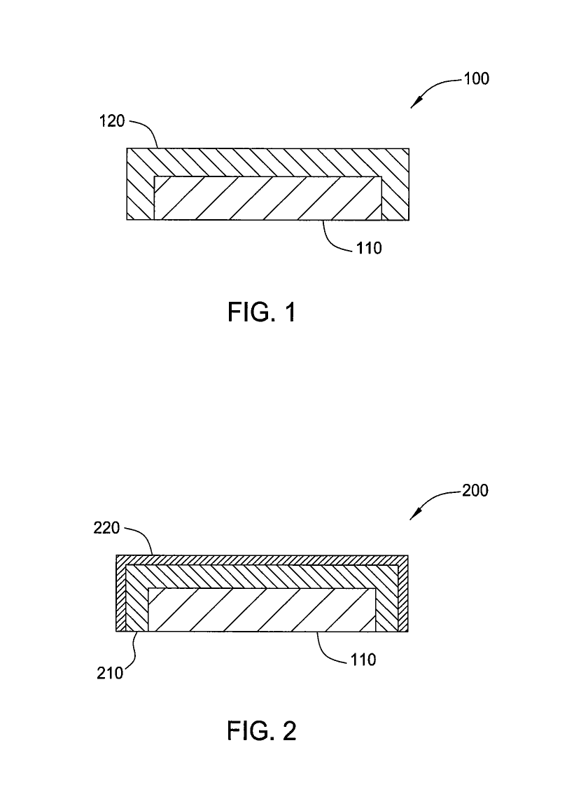

FIG. 1 is a schematic cross-sectional view of an article 100 according to one embodiment. The article 100 is a synthetic structural article that may be used for external wood-replacement applications requiring strong weather resistance, such as fencing, decking, railing, siding, and the like. The article 100 comprises a rigid extruded core 110 and a cap layer 120. The core 110 typically comprises a polymeric material, and may be a solid polymeric material, a cellulosic composite (e.g. with wood or flax fiber), or a foam or gel of either material. Exemplary core materials include, but are not limited to, PVC and polyethylene (PE).

The cap layer 120 is typically a polymeric material selected for weather resistance, texturability, and colorablity, and alloyed for resistance to burning and wear. The cap layer 120 is generally thermoplastic for easy processing and/or shaping, and may be cross-linked to improve overall strength, melt strength, viscosity, weather resistance, and scratch and mar performance. The polymeric material may also be alloyed with an FR component to achieve high resistance to burning. The FR may be a halogen-containing polymer, such as a halogenated polymer. The halogen-containing polymer typically has halogen atoms attached to the polymer backbone, but halogen atoms attached to side groups pendant from the polymer backbone may also improve flame resistance. Some examples of FR include PVC and chlorinated PVC (CPVC). PVC is a polymer formed from vinyl chloride, H2C=CHCl, wherein every other carbon atom of the polymer chain has one chlorine atom attached. Chlorinated PVC is a PVC polymer to which additional chlorine has been added to create a polymer more densely chlorinated than PVC. Some embodiments of CPVC are fully chlorinated polymers having essentially no attached hydrogen. If should be noted that halogenated polymers having halogens other than chlorine, such as fluorine and bromine (e.g. fluorinated or brominated polymers), may also be used as FR. Mixtures of any of the above agents may also be used as FR.

Halogenated polymers such as PVC are difficult to burn. Without being bound by theory, it is thought that the presence of chlorine deters oxidation of carbon atoms by reducing access of oxygen atoms to the hydrogen atoms bonded to the carbon chain. Chlorine atoms (and all halogens) are large, and their presence at every other carbon atom creates a barrier preventing oxygen molecules, which are also large, from approaching the hydrogen atoms that are bonded close to the carbon atoms. It is believed that the chlorine canopy thus effectively prevents reaction between the oxygen and hydrogen that characterizes combustion of a hydrocarbon for all but very high energy reactions. Also, any chlorine atoms that are detached from the main chain by a collision with an oxygen molecule become highly reactive radicals that may react with other chlorine radicals to become diatomic chlorine, diluting the oxygen concentration around the carbon chain and reducing oxygen reactivity with the carbon, or may react with the carbon chain to chlorinate the carbon chain at other sites, increasing the chlorine canopy density of the rest of the polymer chain.

The cap layer 120 may be formed by extruding a mixture of a TPU and a halogen-containing polymer. A mixture of the TPU and the halogen-containing polymer may be from about 0% of the halogen-containing polymer by weight (i.e. neat TPU) to about 75% of the halogen-containing polymer, depending on the degree of flame resistance desired. Each of the polymer materials may be provided for mixing in powder form or pellet form. Additionally, the TPU may be provided as urethane reaction components, isocyanate and isocyanate-reactive components, which are reacted in the presence of the FR to produce a polymerization alloy. Commercially available TPU materials that may be used to make a flame retardant blend according to methods described herein include, but are not limited to, Elastollan® A 1154 0, Elastollan A 1185 A, and Elastollan LP9313. In addition to, or instead of, these polyether-based TPU materials, polyester-based TPU materials may be used.

Strength and hardness of the cap layer 120 may be developed using various methods. In one aspect, a radical initiator may be blended with the TPU/FR mixture (or neat TPU) in an extruder. The radical initiator promotes radical polymerization of the molecules in the mixture, primarily affecting the electron-poor TPU component. The TPU is thus encouraged to cross-link to form a strong polymeric matrix with small domains of FR material incorporated therein. Organic peroxides such as bisperoxide (bis-(tbutylperoxy isopropyl)benzene), dicumyl peroxide, and t-butyl cumyl peroxide may be blended to a concentration between about 0.0% and about 10.0% by weight of the total blend. The amount of initiator added to the blend affects the speed with which strength and hardness develops. Considerations such as shelf-time and temperature, stabilizers or other additives to be used in the blend, and degree of final cross-linking desired affect the amount of initiator used. Other components, such as excess isocyanates, amines, amides, aziridines, diols, triols, and silanes may be used instead of, or in addition to, radical initiators to promote cross-linking.

In one example, mechanical properties may be improved by adjusting the amount of isocyanate incorporated in the polyurethane matrix of the alloy. Increasing the isocyanate content of the polymer increases the concentration of urethane linkages in the alloy, hardening the polymer alloy.

Extrusion provides energy to activate the cross-linking reaction. The blend described above may be processed using a single-screw or twin-screw extruder operating at a specific energy input rate between about 0.18 and about 0.59 hp/lb/hr. Such conditions typically result in a temperature, as measured in the heating section of the extruder, between about 140° C. and about 220° C. Higher processing temperatures may promote faster cross-linking and result in a harder final product in some cases. Higher processing temperatures may also add color, depending on the concentration of antioxidants in the blend.

Other methods may be used to develop strength and hardness. For example, chain extenders such as amines may be used in some embodiments. Trimerization catalysts may also be used to increase strength, if desired. These methods may be used alone or in any combination.

TPU materials are generally dried prior to processing to prevent degradation of physical properties like tensile strength, abrasion resistance, and tear resistance during processing. Moisture content of the TPU is typically reduced to less than about 0.5% prior to processing by heating to a temperature between about 60° C. and about 70° C. in a heated desiccant dryer, convection oven, or vacuum oven. The heaters described above may be coupled to a closed hopper system for feeding directly into an extruder.

Co-agents may be added to control side-reactions that may occur during cross-linking and blending. Co-agents may improve heat aging, modulus, tensile strength, tear strength, hardness, abrasion resistance, compression set, and adhesion to metal, properties that may be adversely affected by chain scission during processing. Co-agents that increase cure rate include acrylates, methacrylates, and maleimides. Polybutadienes and allyl species, such as triallyl cyanurate, triallyl isocyanurate, and diallyl phthalate, may be used to augment cross-linking without increasing cure rate. Co-agents may be added to a concentration between about 0.0% and about 3.0% by weight of the total blend.

Scorch preventers such as phenolics, phosphites, thioesters, and aromatic amines may be added to delay activity of the radical initiator in the event a shelf-time is anticipated between blending the TPU with the initiator and final extrusion of the structural article. The scorch preventers, which may also function as antioxidants, may be added to a concentration between about 0.00% and about 3.0% by weight of the total blend.

Other additives that may be used include lubricants, colorants, plasticizers, stabilizers, other flame retardants, and deglossing agents. Lubricants, including amide waxes, PE waxes, fatty acids, and stearic acids, may be added to a concentration between about 0.0% and about 3.0% by weight of the total blend. Plasticizers such as dioctyl terephalate and epoxidized soybean oil may be added to a concentration between about 0.0% and about 5.0% by weight of the total blend. Pigments and/or color concentrates may be added to a concentration between about 0.0% and about 9.0% by weight of the total blend. Stabilizers such as UV absorbers, antioxidants, and hindered amine light stabilizers may be added to a concentration between about 0.0% and about 5.0% by weight of the total blend. Other FR materials such as zinc stannate, zinc borate, magnesium hydroxide, antimony, liquid phosphates, and other phosphorus based FR may be added to a concentration between about 0.0% and about 20.0% by weight of the total blend to further enhance flame resistance. Deglossing agents such as other cross-linked polymers, high melt temperature polymers, and mineral based products such as talc may be added to a concentration between about 0.0% and about 5.0% by weight of the total blend.

The core 110 generally has dimensions typical of structural members, such as wood boards used for decking, siding, fencing, and the like. The cap layer 120 is a thin coating layer that may have thickness between about 2.5 mils and about 35 mils, depending on the application, and which may vary at different locations on the article.

FIG. 2 is a schematic cross-sectional view of an article 200 according to another embodiment. The article 200 is also a structural article usable for similar applications as the article 100 of FIG. 1. The article 200 comprises the rigid core 110, an intermediate layer 210, and a cap layer 220. The intermediate layer 210 may be a cap layer similar to the cap layer 120, or may be a tie layer comprising a bonding material such as any of the resins previously mentioned, or any other resins compatible with the core material, such as PVC or PE. A tie layer may be used, for example, with a PE or modified PE core material (foam or solid) to improve adhesion of the cap layer to the core. The cap layer 220 is generally similar to the cap layer 120 of FIG. 1, but may be thinner when the intermediate layer 210 has a similar composition. For example, if the intermediate layer 210 has a lower level of cross-linking than the cap layer 220, in order to make the intermediate layer 210 more adhesive, the intermediate layer may have a thickness between about 2.5 mils and about 30 mils, and the cap layer 220 may have thickness less than about 4 mils, for example between 1 mil and 4 mils. If the intermediate layer 210 is a tie layer, the tie layer will have thickness between about 5 mils and about 20 mils, such as about 10 mils. In one embodiment, the tie layer may include maleic anhydride, or another polar component.

The articles 100 and 200 of FIGS. 1 and 2 are co-extruded articles. The core material may be extruded from PVC foam or extrusion foamed from PVC or PE based pellets or powder. The cap layers 120 and 220 may be reactively extruded, depending on the desired blend. A first extrusion is typically performed to blend the TPU material, the FR material, and the additives into a substantially homogeneous intermediate material, and the intermediate material is applied to the structural article in a second extrusion process. During the first extrusion, the presence of stabilizers, inhibitors, and anti-scorch agents, along with relatively light extrusion conditions, subdues activity of the radical initiator blended with the resin, reducing cross-linking during the first extrusion. During the second extrusion, a high-intensity period is typically employed to quench the various inhibitors and activate the radical initiator to start the cross-linking reaction. The structural article is extruded prior to substantial cross-linking, and the article is allowed to cure and harden for 24 hours to one week prior to use. It should be noted that depending on the embodiment, the heat history of the final product may be selected to perform a portion of the cross-linking during the first extrusion and/or the second extrusion processes.

In another embodiment, in addition to the adjustment processes described above, development of the polyurethane matrix itself may be controlled during the reactive extrusion process by adjusting the mixing point of the reactive precursors. A polyol precursor having a FR component dispersed therein may be provided to the first extruder, and the isocyanate component injected at a desired point along the first extruder or the second extruder to balance growth of the polyurethane matrix with extrusion cracking of the polymer molecules.

The articles 100 and 200 of FIGS. 1 and 2 are shown with layers, i.e. the cap layer 120 or the intermediate and cap layers 210 and 220, covering three sides of the core 110, but alternate embodiments may have layers covering only one side of the core or all four sides of the core (or six sides if the ends of the article are coated).

Finished articles manufactured according to methods described herein generally have good scratch and abrasion resistance. Scratch and abrasion resistance may be measured using a weighted probe having a pointed end applied to a surface of the article. A lateral force is applied to the probe to “drag” the probe across the article surface, and the depth of any mark made on the article surface is measured. In one embodiment, a similar test is conducted using probes having points measuring 1 mm in width and 7 mm in width to determine scratch propensity under different conditions. Different weights may be applied to the different probes. When tested using probes weighing up to 20 N, for example between about 3 N and about 20 N, articles produced by the methods described herein generally exhibit either no scratching or marring, or only shallow, smooth, consistent scratching barely visible to the naked eye, difficult to measure, and not possible to feel. Marring under similar test conditions will be difficult to detect or cannot be detected by visual inspection.

In one aspect, a core member of a structural article, such as the core member 110 is extruded at an elevated temperature and then cooled before applying the cap layer 120 or 220 to promote adhesion of the cap layer 120 or 220 and to promote rapid solidification of the cap layer 120 or 220 prior to contact with handling equipment. A surface of the core member may be smoothed using, for example, a Celuka process or a modified Celuka process in which a foaming melt is extruded into a cooled calendaring die such that the cooled die suppresses foaming at the skin of the extruded article. The TPU materials may then be extruded and applied to the core member 110 as a melt using a crosshead die. The melt typically has high fluidity and low viscosity to allow formation of a thin layer of cap material. In some embodiments. TPU's used in formulations described herein may have ML Mooney viscosity (ASTM D1646-07) between about 10 and about 100. Extruding the TPU cap material onto a hot core prolongs the softened state of the TPU material, causing potential damage to the cap layer when it contacts handling equipment such as rollers.

A post-extrusion process may be used to apply the cap layer to the core member. The core member is extruded onto a cooling table, which cools the extruded member by flowing cool air, water, or mist over the core member. Duration under the coolant flow determines the amount of cooling, and the amount of cooling desired generally depends on the cap layer rheological characteristics. It is generally advantageous for the cap layer to cool to a solidification temperature prior to calibration to avoid damaging the cap layer. The TPU melt is applied to the cooled core member such that the desired solidification occurs before the finished article contacts rollers, grippers, or other handling equipment.

The degree of flame resistance of the finished article may depend on the thickness of the cap layer. If the core member has very high flame resistance, for example if the core member is PVC or another highly flame-resistant material, the TPU cap material may have lower flame resistance than the core member. In such cases, a thick cap layer will yield a finished article with lower flame resistance than a thin cap layer. In some instances, a thin cap layer of flame resistant TPU, as described herein, having a thickness between about 2 mils and about 30 mils covering a 2″×4″ (nominal) PVC article may achieve an ASTM E84 class A flame resistance. Use of thinner cap layers reduces the resistance of the cap layer to physical impacts, so use of a surface hardening process, such as the Celuka or modified Celuka process, on the core member before capping may reduce damage to the surface of the core member underlying the thin cap layer.

While the foregoing is directed to embodiments of the invention, other and further embodiments of the invention may be devised without departing from the basic scope thereof.

What is claimed is:

1. A flame retardant thermoplastic resin alloy, comprising:
a thermoplastic urethane; and
a halogen-containing polymer.

2. The flame retardant thermoplastic resin alloy of claim 1, wherein the halogen-containing polymer is a polymer having halogen atoms bonded to the polymer backbone.

3. The flame retardant thermoplastic resin alloy of claim 2, wherein the thermoplastic urethane is cross-linked.

4. The flame retardant thermoplastic resin alloy of claim 2, wherein the halogen-containing polymer is PVC or chlorinated PVC.

5. The flame retardant thermoplastic resin alloy of claim 1, wherein the thermoplastic urethane is cross-linked.

6. The flame retardant thermoplastic resin alloy of claim 5, wherein the halogen-containing polymer is PVC or chlorinated PVC.

7. The flame retardant thermoplastic resin alloy of claim 5, further comprising a metal salt or a phosphate.

8. The flame retardant thermoplastic resin alloy of claim 1, further comprising a metal salt or a phosphate.

9. The flame retardant thermoplastic resin alloy of claim 8, wherein the thermoplastic urethane is cross-linked and the halogen-containing polymer is PVC or chlorinated PVC.

10. A structural article, comprising:
a structural core and a capping material disposed on the structural core, the capping material comprising a thermoplastic urethane and a halogen-containing polymer.

11. The structural article of claim 10, wherein the capping material is extruded to a thickness between about 4 mils and about 30 mils.

12. The structural article of claim 10, wherein the halogen-containing polymer is a polymer having halogen atoms bonded to the polymer backbone.

13. The structural article of claim 11, wherein the halogen-containing polymer is PVC or chlorinated PVC.

14. The structural article of claim 13, wherein the thermoplastic urethane is crosslinked.

15. The structural article of claim 14, further comprising a metal salt or a phosphate.

16. A structural article, comprising:
a structural core;
a capping material disposed over the structural core; and
an intermediate layer between the structural core and the capping material, the capping material comprising a thermoplastic urethane and a halogen-containing polymer.

17. A method of processing a structural article, comprising:
forming an intermediate blend of a thermoplastic urethane material and a halogen-containing polymer in a first extrusion process;
applying the intermediate blend to the structural article in a second extrusion process; and
curing the intermediate blend.

18. The method of claim 17, wherein forming the intermediate blend comprises blending the thermoplastic urethane material and the halogen-containing polymer with a radical initiator, and applying the intermediate blend to the structural article comprises activating the radical initiator to cross-link the thermoplastic urethane material.

19. The method of claim 17, wherein applying the intermediate blend to the structural article comprises performing a post-extrusion process after the structural article is cooled.

20. The method of claim 19, wherein cooling the structural article comprises extruding the structural article through a cooled die.

21. The method of claim 19, wherein cooling the structural article comprises extruding the structural article onto a cooling table.
